(19) United States
(12) Patent Application Publication
(10) Pub. No.: US 2016/0145914 A1
(43) Pub. Date: May 26, 2016

(54) Door stop block

(71) Applicant: Robert Fuentes, Moore, OK (US)

(72) Inventor: Robert Fuentes, Moore, OK (US)

(21) Appl. No.: 14/544,097

(22) Filed: Nov. 24, 2014

(51) Int. Cl. E05C 17/54

(52) U.S. Cl. CPC E05C 17/54

(57) ABSTRACT

A quick application magnetic door stop block, magnetically attaching to a door hinge plate to prevent the door from being closed and for holding the door in a fixed open position, the block providing a squared block with a strong magnet inset on an inner surface of the block, the magnet holding the block in place on the door frame hinge plate.

### CROSS REFERENCE TO RELATED APPLICATIONS

None.

### BACKGROUND OF THE INVENTION

1. Field of Invention

A quick application magnetic door stop block, magnetically attaching to a door hinge plate to prevent the door from being closed and for holding the door in a fixed open position, the block providing a squared block with a strong magnet inset on an inner surface of the block, the magnet holding the block in place on the door frame hinge plate.

2. Description of Prior Art

A preliminary review of prior art patents was conducted by the applicant which reveal prior art patents in a similar field or having similar use. However, the prior art inventions do not disclose the same or similar elements as the present door stop block, nor do they present the material components in a manner contemplated or anticipated in the prior art.

Several door stops disclose some type of deformable wedge which is inserted into the space between the door and the door frame to prevent closure of the door. These door blocks or door stops are indicated in U.S. Pat. No. 8,458,958 to Cress, U.S. Pat. No. 4,878,267 to Roach, an integrated hinge pin door stop or U.S. Pat. No. 3,325,854 to Steigerwald, D323,976 to Barnes, and Patent Publication No. 2008/0079270 to Carlson.

A slim profile device, disclosed in U.S. Pat. No. 8,727,404 to Martin, is a plate having a several magnets glued to a first surface and a foam layer glued to the first surface, comprising a laminated flat bar. FIG. 4 shows the bar magnetically attached to the hinge plate of a door, FIG. 5 showing the bar wedged between the door and the frame without any magnetic involvement, and FIGS. 7A and 7B show the plate magnetically attached to the strike plate over the latch portion of the door frame opposite the hinged side of the door. The device use is to prevent an automatic closure door from closing in an emergency situation, primarily used in fighting a fire. Another shaped door stop is disclosed in U.S. Publication No. 2014/0225385 to Millsap. That patent application discloses a block structure with a set of magnets on flat surface and another magnet on a perpendicular flat surface of the block. It has a somewhat rectangular structure with a cutout portion (curved) which is meant to adapt to a hinge pin and hasps with a set width which biases and fills the complete gap between the hinge pin and the edge of the door jamb. This acts as a wedge which is oriented on a horizontal axis. When installed, it is designed to maintain the door in a completely open position and does not allow for movement of the door to a partially open position. It is also magnetically attached to the hinge plates on both sides of the hinge, FIG. 2, instead of magnetically attaching to a single plate.

### SUMMARY OF THE INVENTION

Door stops are used to either hold a door in a selected open position or to prevent a door from complete closure, as noted in the prior art. Reasons for use include maintaining a door in a open position for safety purposes, such as a firefighter would use during a fire, for convenience to keep a door from closing when moving objects through a doorway, or to prevent an automatic door from closing or locking out someone who prefers immediate reentry without having to unlock a door. As noted in the prior art, using a type of wedge, either under the door or inserted somewhere within the closure side of the door has many different presentation, some by design and other by their utility and stated attachment to the door, frame or hinge. There are some which utilize a magnet within the door stop mechanism for stability or for blocking a particular engagement of door components.

The present magnetic door stop is a simply block with a strong magnet imbedded within an inner surface providing a magnetic attachment to a door frame hinge plate, and a lift groove on an inner corner to accommodate disengagement of the block from the hinge plate. The block can be moved sideways to allow for a range opening of the door between a full open position and a partial opening of the door. It is preferred that the disclosed door stop be used in pairs to prevent incidental deformation of the door hinges or damage to the door or frame in the event an unusually aggressive force occurs on the door during use of the door stops.

The primary objective of the invention is to provide

### DESCRIPTION OF THE DRAWINGS

The following drawings are submitted with this utility patent application.

FIG. 1 is an inner surface perspective view of the magnetic stop block.

FIG. 2 is a top perspective view of a door, door frame and door hinge with the magnetic door stop installed in an intended use.

FIG. 3 is a sectional view along sectional lines 3/3 of FIGS. 2, indicating the magnetic door stop applied to the hinge plate on the door frame side of the door hinge.

FIG. 4 is a sectional view along lines 4/4 of FIG. 3, indicating engagement of the imbedded magnet on the inner surface of the door stop block attaching to the door frame hinge plate.

### DESCRIPTION OF THE PREFERRED EMBODIMENT

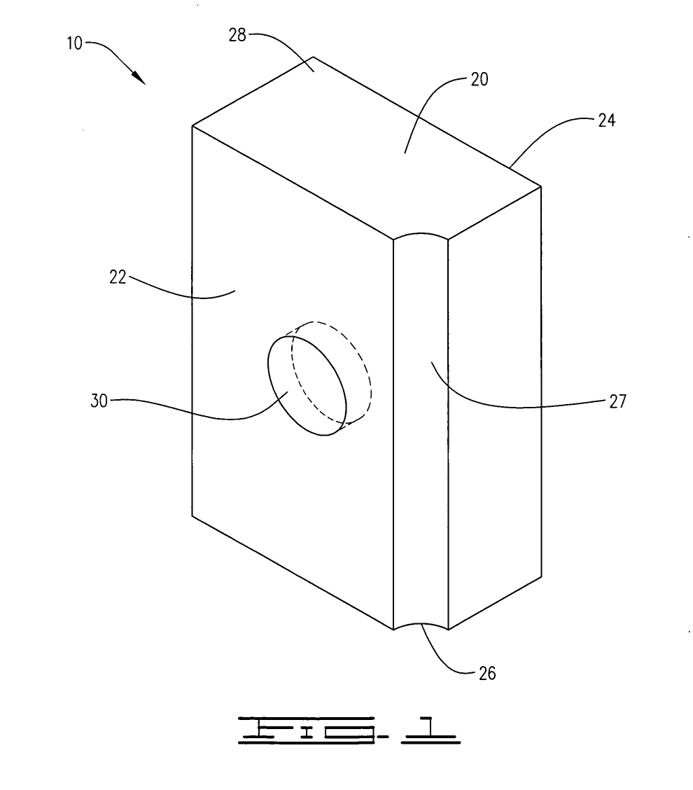

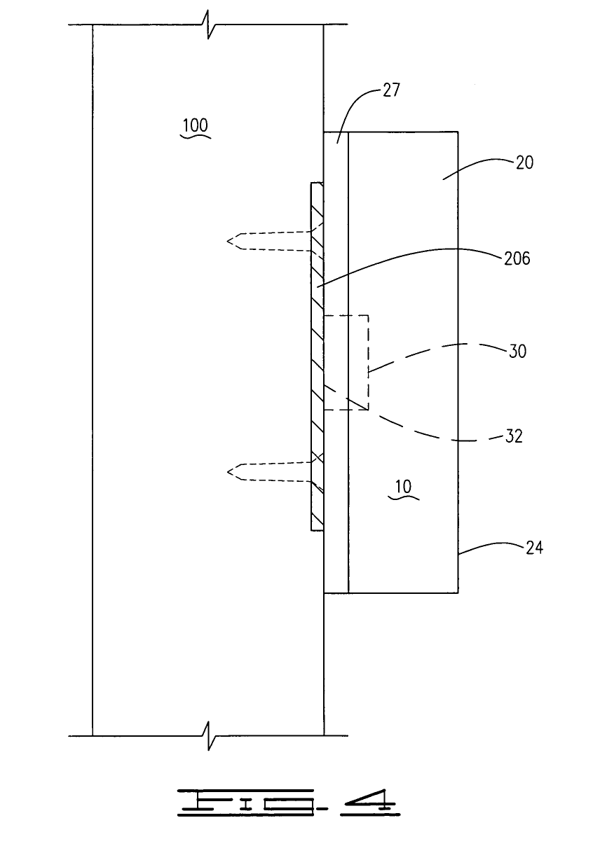

A magnetic stop block 10 attaching to a hinge plate 202, 206 on a door 110 hung within a door frame 100 having a door jamb 102, shown in FIGS. 1-4 of the drawings, provides temporary blockage of the door from closing at a preferred open location, the stop block 10 comprising a block member 20 having an inner surface 22 within which is imbedded a strong magnet 30 having an outer surface 32 flush with the inner surface 22 of the block member 20, the inner surface 22 providing a pry ridge 27 which is carved into a corner edge 26 of the inner surface 22, the pry ridge 27 providing a location to insert finger tips to pry the block member 20 and disengage the strong magnet 30 from an applied hinge plate 202, 206. The block member 20 further defines an outer contact edge 28 extending from an outside surface 24 of the block member 20, which is exposed upon installation most proximally to an inner edge 112 of the 110 door.

It is preferred that two stop blocks 10 be applied to two door hinges 200 on the same door, one high and one low, to prevent a door 110 from being forcibly bent or a hinge 200 on the door 110 from being deformed in the event and excessive force is applied to the door while the door stop 10 is in use, with two stop blocks 10 on two hinges 200 potentially avoiding damage or deformity better than a single stop block 10.

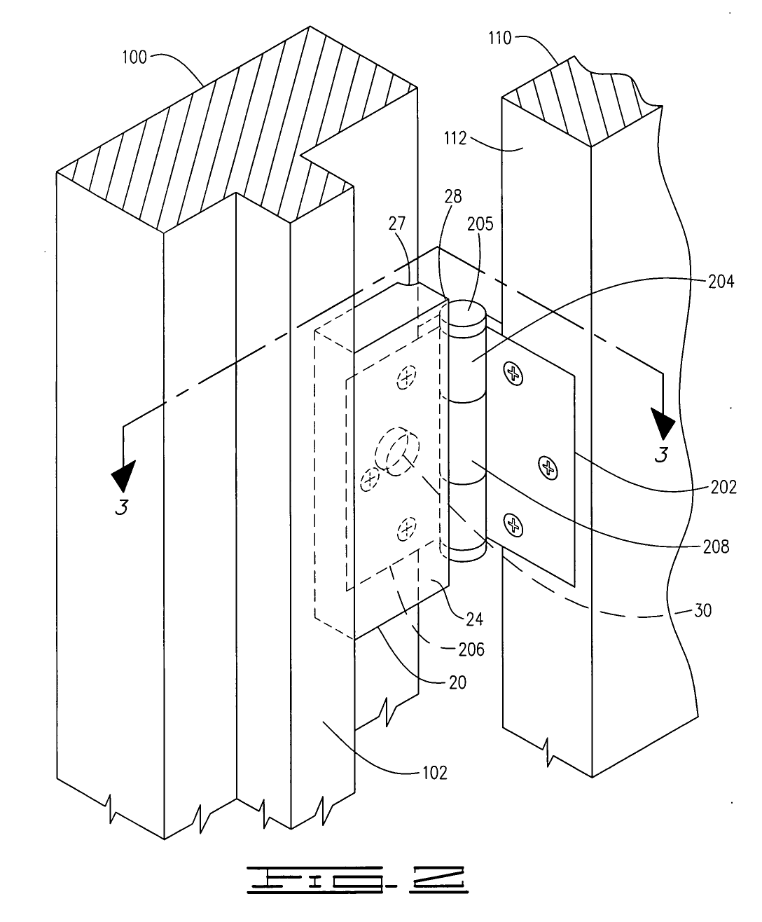

The stop block 10 is properly applied as depicted in FIGS. 2-4, with the outer surface 32 of the strong magnet 30 facing the metal hinge plate 202, 206, preferably on the frame hinge plate 206. FIG. 2 clearly demonstrates the components of a standard door assembly to which the stop block 10 is applied, comprising a door frame 100, an extended door jamb 102 and a swinging door 110, with a hinge 200 defining a door hinge plate 202 extending an inner hinge member 204, a frame hinge plate 206 extending an inner hinge member 208 and a hinge pin 205 inserted through the joined and aligned inner hinge members 204, 208, forming the hinged connection. FIG. 2 further discloses the preferred location of the stop block 10 relative to the frame hinge plate 206 and door frame 100. As shown, the pry ridge 27 faces the hinge pin 205, but does not contact the inner hinge member 208 and is preferably abutted against the door jamb 102, allowing for the placement and removal of the stop block 10 leaving access to the pry ridge 27 for disengaging the strong magnet 30 from the frame hinge plate 206.

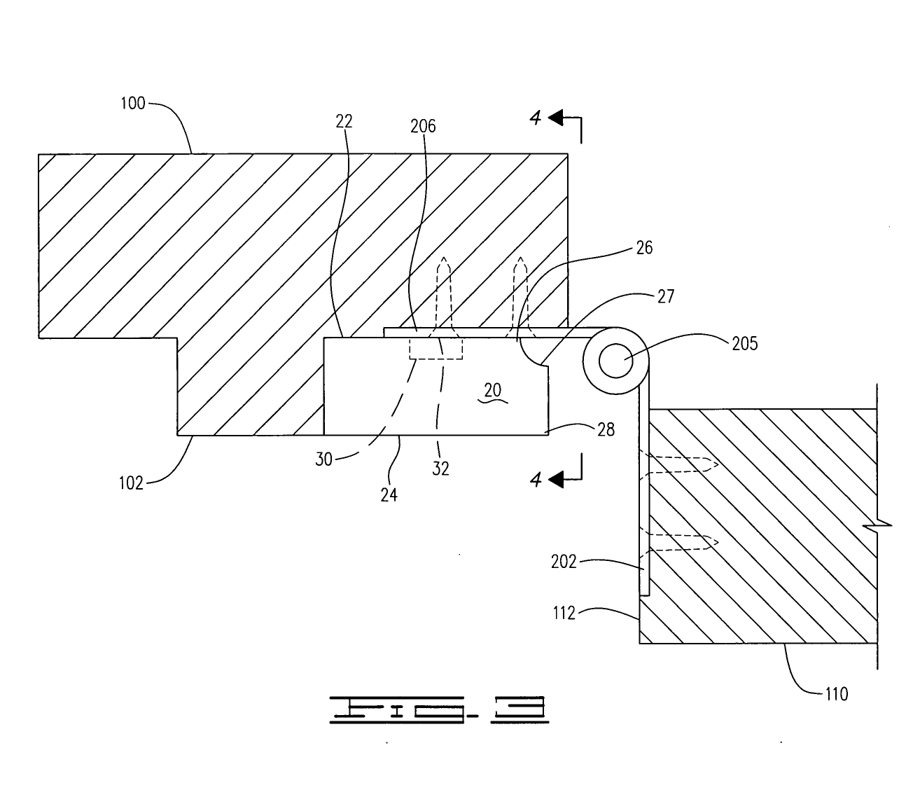

The block member 20 does not necessarily need to be square, although a square shape would be optimal for the disclosed purpose. It is preferred that the depth of the block member 20 be equal to the width of the door jamb 102 from the door frame 100, as shown in FIG. 3, and that the width of the block member 20 is narrow enough to allow space between the hinge pin 205 and the pry ridge 27 of the corner edge 26. Other pry ridges may be included in the block member 27 for other pry points to disengage the strong magnet 30 from the hinge plate 202, 206, not shown. It is not recommended that the stop block 20 be installed on the door hinge plate 202 of the hinge 200, which is a moving component of the door assembly during opening and closing of the door, as this installation has a tendency to dislodge or displace the stop block 10 more readily than would occur when the stop block 20 is applied to the stationary frame hinge plate 206 of the hinge 200.

While the stop block 10 has been particularly shown and described with reference to a preferred embodiment thereof, it will be understood by those skilled in the art that changes in form and detail may be made therein without departing from the spirit and scope of the invention.

What is claimed is:

1. A magnetic stop block attaching to a hinge plate of a hinge of a door hung within a door frame having a door jamb, said stop block providing temporary blockage of the door from closing and holding said door in a selected open position, said stop block comprising:
a block member defining an inner surface having a corner edge containing a pry ridge and an outer surface forming an outer contact edge; and
as strong magnet embedded within said inner surface having an outer surface flush with said inner surface of said block member, wherein said strong magnet attached said stop block to said hinge plate of said hinge with said pry ridge away from said door jamb allowing access to said pry ridge for removal of said stop block from said hinge plate and said contact edge is directed to an inner edge of said door upon application of said stop block to said hinge plate.

2. The stop block as disclosed in claim 1, wherein said stop block are supplied and applied in pairs, with one said stop block applied to each of at least two hinges attaching said door to said frame, not for the mere purpose of duplicating said stop block but to avoid deformation of said door and said hinges from the force of said door closing against said stop block applied to said hinge plate.

3. The stop block as disclosed in claim 1, further defining said block member having a rectangular shape defining a depth measuring between said inner surface and said outside surface equal to a width of said door jamb from said door frame.

4. The stop block as defined in claim 1, said hinge to which said stop block is applied defines a door hinge plate extending an inner hinge member, a frame hinge plate extending an inner hinge member and a hinge pin inserted through the joined and aligned inner hinge members, with said stop block attaching only to said frame hinge plate to avoid dislodgment or displacement of said stop block as opposed to the application to said door hinge plate.

5. The stop block as disclosed in claim 1, further comprising other components included within the specification.
